(19) United States
(12) Patent Application Publication
(10) Pub. No.: US 2026/0228497 A1
(43) Pub. Date: Aug. 6, 2026

(54) SCHEMATIC MIGRATION WITH ARTIFICIAL INTELLIGENCE ASSISTED ELECTRICAL MAPPING SOLUTION

(71) Applicant: TAIWAN SEMICONDUCTOR MANUFACTURING COMPANY LTD., HSINCHU (TW)

(72) Inventors: ZONG-YING HO, HSINCHU COUNTY (TW); MING CHIEH LI, HSINCHU COUNTY (TW); HSIEN YU TSENG, MIAOLI COUNTY (TW); WEI-MING CHEN, KEELUNG CITY (TW)

(21) Appl. No.: 19/044,650

(22) Filed: Feb. 4, 2025

(51) Int. Cl. G06N 3/0455; G06N 3/09

(52) U.S. Cl. CPC G06N 3/0455; G06N 3/09

(57) ABSTRACT

The present disclosure provides a method which includes the following steps: obtaining, by a processor, a first device parameter set associated with a specific electrical device utilizing a first technology node; predicting, by the processor, a performance of the specific electrical device using a first machine-learning model for the first technology node; and obtaining, by the processor, a second device parameter set associated with a target electrical device, which utilizes a second technology node, using a second machine-learning model associated with the second technology node based on the predicted performance.

### BACKGROUND

Users often seek to transfer their designs to new nodes for performance or business purposes. However, migrating a design to a different process node while maintaining similar performance presents significant challenges. Reproducing the performance and functionality on a new node is a time-intensive process. Achieving comparable device performance across different nodes requires considerable effort. Additionally, the mapping table must be recreated for each node, design, or device migration, further complicating the transition.

### BRIEF DESCRIPTION OF THE DRAWINGS

Aspects of the present disclosure are best understood from the following detailed description when read with the accompanying figures. It is emphasized that, in accordance with standard practice in the industry, various features are not drawn to scale. In fact, the dimensions of the various features can be arbitrarily increased or reduced for clarity of discussion.

FIG. 1 is a block diagram of an IC design system 100 in accordance with some embodiments.

FIG. 2 is a diagram illustrating an AI-assisted schematic migration procedure between two nodes in accordance with some embodiments of the present disclosure.

FIG. 3 is a flowchart of a method for training machine-learning models for a plurality of technology nodes in accordance with some embodiments of the present disclosure.

FIG. 4 is a diagram illustrating the training procedure of a machine-learning model of a specific technology node in accordance with some embodiments of the present disclosure.

FIG. 5 is a diagram illustrating mutual recipe search for a specific electrical device between different technology nodes in accordance with some embodiments of the present disclosure.

FIG. 6 is a diagram illustrating the flow for selecting the most suitable electrical device from a plurality of technology nodes in accordance with some embodiments of the present disclosure.

FIG. 7 is a diagram illustrating the flow for selecting the most suitable electrical device from a plurality of technology nodes using an input device parameter set and an additional constraint in accordance with some embodiments of the present disclosure.

FIG. 8 is a flowchart of a method for schematic migration of an electrical component between different technology nodes in accordance with some embodiments of the present disclosure.

FIG. 9 is a block diagram of an IC manufacturing system 900, and an IC manufacturing flow associated therewith, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features can be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Further, it will be understood that when an element is referred to as being “connected to” or “coupled to” another element, it can be directly connected to or coupled to the other element, or intervening elements can be present.

Embodiments, or examples, illustrated in the drawings are disclosed as follows using specific language. It will nevertheless be understood that the embodiments and examples are not intended to be limiting. Any alterations or modifications in the disclosed embodiments, and any further applications of the principles disclosed in this document are contemplated as would normally occur to one of ordinary skill in the pertinent art.

Further, it is understood that several processing steps and/or features of a device can be only briefly described. Also, additional processing steps and/or features can be added, and certain of the following processing steps and/or features can be removed or changed while still implementing the claims. Thus, it is understood that the following descriptions represent examples only, and are not intended to suggest that one or more steps or features are required.

In addition, the present disclosure may repeat reference numerals and/or letters in the various examples. This repetition is for the purpose of simplicity and clarity and does not in itself dictate a relationship between the various embodiments and/or configurations discussed.

As used herein, the term “technology node” (or “wafer node”, “process node”, “process technology node”, or “node”) refers to a parameter in a specific semiconductor manufacturing process and its design rules. For example, the technology node used herein may be defined by a minimum gate width of a chip. A smaller technology node corresponds to a smaller feature size, which in turn corresponds to smaller transistors.

In integrated circuit (IC) design, a variety of functions are integrated into one chip, and an application specific integrated circuit (ASIC) or system on a chip (SOC) cell based design is often used. In this approach, a library of known functions is provided, and after the functional design of the device is specified by choosing and connecting these standard functions, and proper operation of the resulting circuit is verified using electronic design automation (EDA) tools, the library elements are mapped on to predefined layout cells, which contain prefigured elements such as transistors. The cells are chosen with the particular semiconductor process nodes and parameters in mind and create a process-parameterized physical representation of the design. The design flow continues from that point by performing placement and routing of the local and global connections needed to form a layout of the completed design using the standard cells.

After the layout is completed, various analysis procedure are performed and the layout is verified to check whether the layout violates any of the various constraints or rules. For example, design rule check (DRC), layout versus schematic (LVS) and electric rule check (ERC) are performed. The DRC is a process of checking whether the layout is successfully completed with a physical measure space according to the design rule, and the LVS is a process of checking whether the layout meets a corresponding circuit diagram. In addition, the ERC is a process of for checking whether devices and wires/nets are electrically well connected therebetween. After design rule checks, design rule verification, timing analysis, critical path analysis, static and dynamic power analysis, and final modifications to the design, a tape out process is performed to produce photomask generation data. This photomask generation (PG) data is then used to create the optical masks used to fabricate the semiconductor device in a photolithographic process at a wafer fabrication facility (FAB). In the tape out process, the database file of the IC is used to make various layers of masks for integrated circuit manufacturing. In some embodiments, the database file is a Graphic Database System (GDS) file (e.g., a GDS file or a GDSII file). Furthermore, the GDS file is the industry's standard format for transfer of IC layout data between design tools of different vendors.

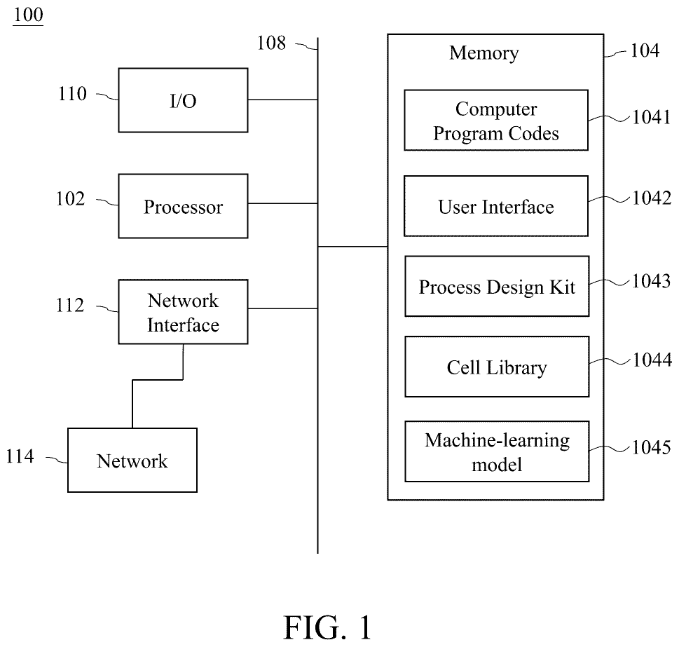

FIG. 1 is a block diagram of an IC design system 100 in accordance with some embodiments. Methods described herein for designing IC layout diagrams and adaptively generating power delivery networks in accordance with one or more embodiments are implementable, for example, using IC design system 100, in accordance with some embodiments.

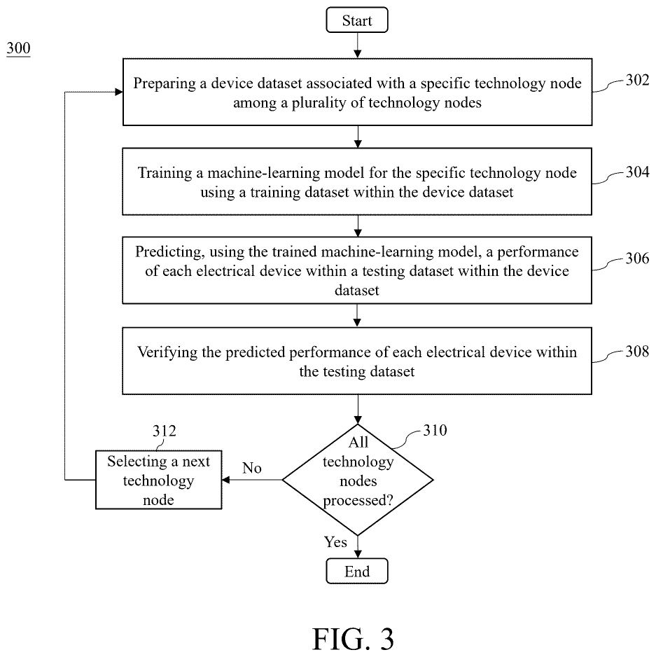

In some embodiments, IC design system 100 is a general purpose computing device including a hardware processor 102 and memory 104. Memory 104 is a non-transitory, computer-readable storage medium. Memory 104, amongst other things, is encoded with, i.e., stores, computer program codes 1041, i.e., a set of executable instructions. Execution of computer program codes 1041 by hardware processor 102 represents (at least in part) an EDA tool which implements a portion or all of a method or flow shown in FIGS. 3 to 8 described later (hereinafter, the noted processes and/or methods).

Processor 102 is electrically coupled to memory 104 via bus 108. Processor 102 is also electrically coupled to an I/O interface 110 through bus 108. Network interface 112 is also electrically connected to processor 102 through bus 108. Network interface 112 is connected to a network 114, so that processor 102 and memory 104 are capable of connecting to external elements via network 114. Processor 102 is configured to execute computer program codes 1041 encoded in memory 104 in order to cause IC design system 100 to be usable for performing a portion or all of the noted processes and/or methods. In one or more embodiments, processor 102 is a central processing unit (CPU), a multi-processor, a distributed processing system, an application specific integrated circuit (ASIC), and/or a suitable processing unit, but the present disclosure is not limited thereto.

In one or more embodiments, memory 104 is an electronic, magnetic, optical, electromagnetic, infrared, and/or a semiconductor system (or apparatus or device). For example, memory 104 may be or include a non-volatile memory such as a semiconductor or solid-state memory, a hard disk drive (HDD), a magnetic tape, a removable computer diskette, a random access memory (RAM), a read-only memory (ROM), a rigid magnetic disk, an optical disk, SD memory card, memory sticks, ferroelectric random access memory (FeRAM), resistive random access memory (RRAM), etc., but the present disclosure is not limited thereto. In one or more embodiments using optical disks, memory 104 includes a compact disk-read only memory (CD-ROM), a compact disk-read/write (CD-R/W), and/or a digital video disc (DVD).

In one or more embodiments, memory 104 stores computer program codes 1041 configured to cause IC design system 100 (where such execution represents (at least in part) the EDA tool) to be usable for performing a portion or all of the noted processes and/or methods. In one or more embodiments, memory 104 also stores information which facilitates performing a portion or all of the noted processes and/or methods.

IC design system 100 includes I/O interface 110. I/O interface 110 is coupled to external circuitry. In one or more embodiments, I/O interface 110 includes a keyboard, keypad, mouse, trackball, trackpad, touchscreen, and/or cursor direction keys for communicating information and commands to processor 102.

In some embodiments, IC design system 100 also includes network interface 112 coupled to processor 102. Network interface 112 allows IC design system 100 to communicate with network 114, to which one or more other computer systems are connected. In some embodiments, network interface 112 includes wireless network interfaces and/or wired network interface. The wireless network interface may include Wi-Fi (802.11), Global System for Mobile Communications (GSM), Enhanced Data rates for GSM Evolution (EDGE), Wideband Code Division Multiple Access (WCDMA), Time Division-Synchronous Code Division Multiple Access (TD-SCDMA), Long Term Evolution (LTE), 4-th Generation (4G), 5-th Generation (5G), 6-th Generation (6G), ultra-wideband (UWB), infrared (IR) protocols, near field communication (NFC) protocols, Wibree, Bluetooth protocols, wireless Universal Serial Bus (USB) protocols, etc. The wired network interfaces may include Ethernet, Universal Serial Bus (USB), Inter Integrated Circuit (I2C), Serial Peripheral Interface (SPI), etc., but the present disclosure is not limited thereto. In one or more embodiments, a portion or all of noted processes and/or methods, is implemented in two or more IC design systems 100.

In some embodiments, IC design system 100 is configured to receive information through I/O interface 110. The information received through I/O interface 110 includes one or more of instructions, data, design rules, libraries of standard cells, and/or other parameters for processing by processor 102. The information is transferred to processor 102 via bus 108. IC design system 100 is configured to receive information related to a user interface through I/O interface 110. The information is stored in memory 104 as user interface (UI) 1043.

In some embodiments, the process design kit (PDK) 1044 may include component description format (CDF) files for a plurality of instances (e.g., electrical components or devices) across various technology nodes. For example, an instance may refer to a field-effect transistor (FET) or a bipolar junction transistor (BJT), with a device parameter set recorded in the respective CDF file for a specific technology node. Depending on the technology node used, a field-effect transistor may be a planar FET, a finFET, or a nanosheet FET, each having a respective device parameter set. In some embodiments, the CDF file of a specific FET may include at least the technology node used and information about the transistor size. Here, the transistor size may refer to a channel width (W) and channel length (L) for a planar FET, a number of fins (nfin) and channel length (L) for a finFET, or a number of channels or nanosheets (n_ns) and channel length (L) for a nanosheet FET. It should be noted that the CDF for each instance is not limited to the technology node and transistor size thereof, and it may include more information.

Cell library 1044 may include one or more cell libraries each storing schematics of a plurality of cells that can be used in a pre-layout simulation process. For example, a cell may refer to a standard cell, an analog cell, a memory cell (e.g., SRAM bit cell), an input/output (I/O) cell, or the like. In some embodiments, each standard cell may be a macro including one or more transistors. Examples of a macro including one logic gate can be an NOT, AND, OR, NAND, NOR, XOR gate, etc. In some embodiments, each cell in the cell library includes a plurality of logic gates. Examples of a macro including plural logic gates or a CMOS complex gate can be a 2-bit full adder, a D flip-flop, a latch, a buffer, and-or-invert gate (AOI), or-and-inverter gate (OAI), etc.

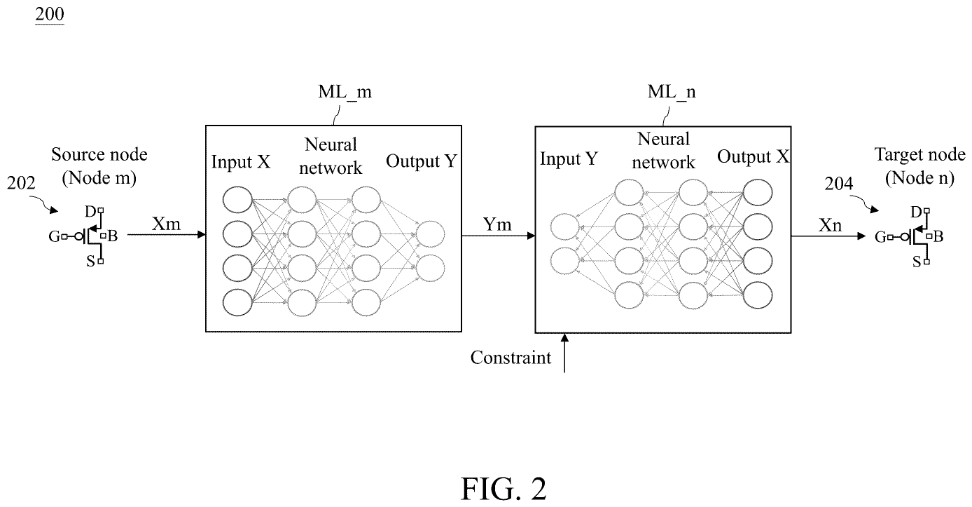

In some embodiments, the machine-learning model 1045 may be a full-node machine-learning model that includes a plurality of machine-learning models (e.g., N machine-learning models ML1 to ML_N, where N is a positive integer greater than 1) across various technology nodes. For example, each of the machine-learning models may be configured to generate predicted performance based on a device parameter set of a specific instance for a respective technology node, and to generate one or more candidate instances based on a specific performance, thereby achieving mutual recipe search between various technology nodes based on either the given device parameter set of a specific technology node or a given performance. Further details will be described in the following embodiments with respect to FIGS. 2 to 8.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by IC design system 100.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

FIG. 2 is a diagram illustrating an AI-assisted schematic migration procedure between two nodes in accordance with some embodiments of the present disclosure.

In some embodiments, the processor 102 may perform the AI-assisted schematic migration procedure 200 to transition instance 202 using a source node (e.g., node m) to instance 204 using a target node (e.g., node n) with a different feature size. For simplicity, the target node may correspond to a smaller feature size, such as minimum gate width or critical dimension, compared to the source node.

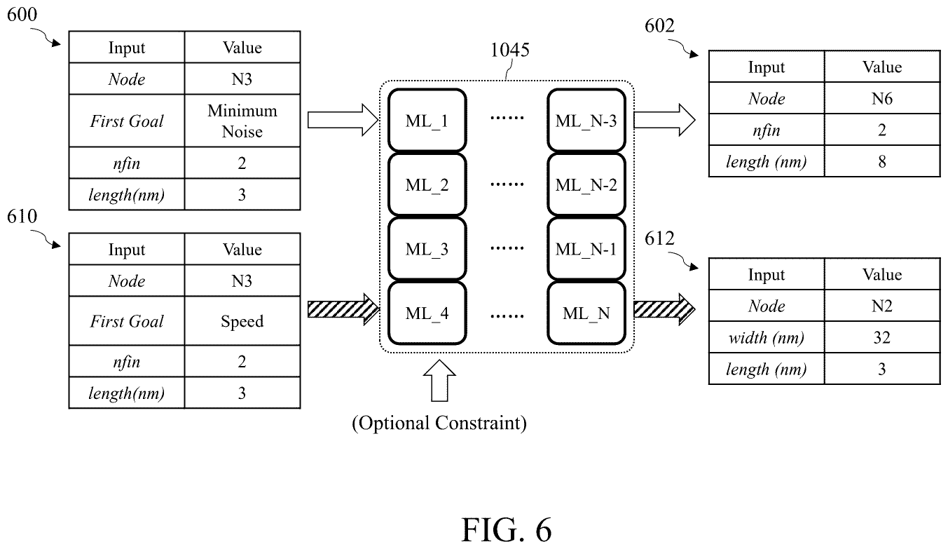

In some embodiments, the machine-learning models ML_1 to ML_N within the machine-learning model 1045 (depicted in FIG. 6) may be invertible machine-learning models, indicating that these models are capable of performing a forward-inference process to generate a predicted performance of a specific instance using a specific node based on its device parameter set, and performing a backward-inference process to generate a device parameter set associated with an instance using the specific node based on a given performance. Examples of invertible machine-learning models may include, but are not limited to, autoencoders, invertible neural networks, generative adversarial networks (GANs), reversible networks, and the like. For example, an autoencoder consists of an encoder that maps the input to a latent space and a decoder that reconstructs the input from this latent space. While not exactly backward inference, the decoder part of an autoencoder can be seen as reconstructing the input from a compressed representation. Additionally, GANs consist of two networks, a generator and a discriminator, that are trained together. The generator learns to produce data that is similar to the training data. While GANs are not directly used for backward inference, they can generate data that resembles the input data distribution. Moreover, invertible neural networks are designed to be invertible, meaning that they can map inputs to outputs and vice versa. Normalizing flows are a type of invertible neural network that can be used to model complex data distributions and allow for both forward and backward inference. Furthermore, reversible networks are similar to invertible networks, and they are designed so that each layer is invertible. This allows for the reconstruction of inputs from outputs.

For purposes of description, the machine-learning model ML_m for the source node (e.g. node m) is a trained machine-learning model, including an invertible neural network with an input X (e.g., device parameter set) and an output Y (e.g., predicted performance, such as transconductance gₘ, saturation current I_{dsat}, and the like) for the source node. Similarly, the machine-learning model ML_n for the target node (e.g. node n) is a trained machine-learning model, including another invertible neural network with an input Y (e.g., device parameter set) and an output X (e.g., predicted performance, such as transconductance gₘ, saturation current I_{dsat}, noise suppression capability, and the like) for the target node. Here, m and n are positive integers between 1 and N.

In some embodiments, the processor 102 may retrieve a first CDF file associated with instance 202 (e.g., a P-type FET with gate, drain, source, and body terminals) using the source node from the PDK 1043, thereby obtaining the device parameter set Xm associated with instance 202. Subsequently, the processor 102 may input the device parameter set Xm associated with instance 202 into the machine-learning model ML_m, such that the machine-learning model ML_m generates predicted performance Ym associated with instance 202.

Afterwards, the processor 102 may input the predicted performance Ym associated with instance 202 into the machine-learning model ML_n for the target node (e.g., node n), such that the machine-learning model ML_n generates a device parameter set associated with an output instance 204 using the target node that has similar performance as instance 202 using the source node. For example, the machine-learning model ML_n may generate one or more candidate instances with their respective device parameter set.

Furthermore, an additional constraint (e.g., cost) can be input into the machine-learning model ML_n, along with the predicted performance Ym of instance 202, thereby assisting in determining the most appropriate output instance from a plurality of candidate instances using the target node.

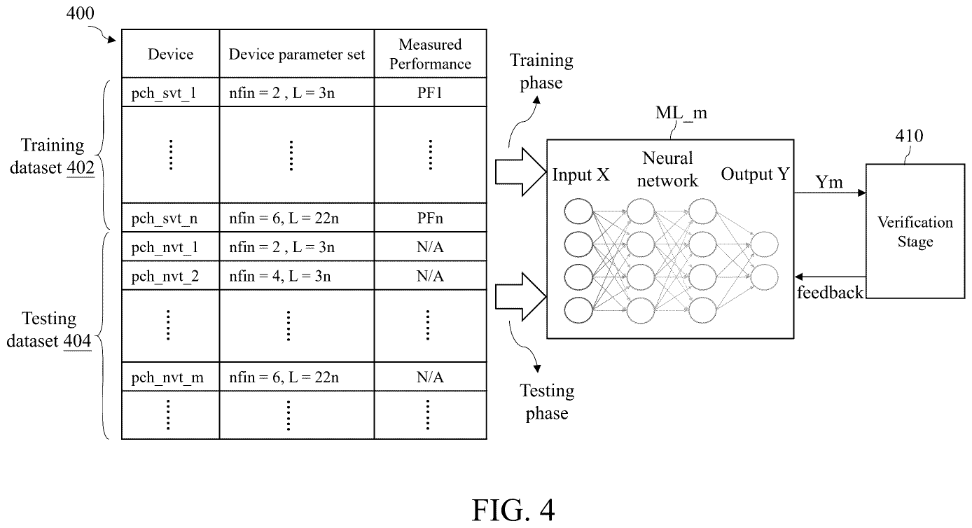

FIG. 3 is a flowchart of a method for training machine-learning models for a plurality of technology nodes in accordance with some embodiments of the present disclosure. FIG. 4 is a diagram illustrating the training procedure of a machine-learning model of a specific technology node in accordance with some embodiments of the present disclosure. Please refer to FIG. 3 and FIG. 4 simultaneously.

In some embodiments, the training procedure of the machine-learning model ML_m for a specific technology node may include a training phase and a testing phase. For brevity, the specific technology may refer to a 3 nm technology node which uses finFET devices. At operation 302, a device dataset 400 associated with a specific node among a plurality of nodes is prepared. For example, the device dataset 400 shown in FIG. 4 is for the specific technology node (e.g., technology node m), and it includes a plurality of electrical devices (or instances) and their respective device parameter sets, such as transistors pch_svt_1 to pch_svt_n. Each device parameter set within the device dataset 400 may include at least a number of fins (nfin) and its length (L).

At operation 304, a machine-learning model ML_m for the specific technology node is trained using a training dataset 402 within the device dataset 400. In some embodiments, the device dataset 400 can be divided in to a training dataset 402 and a testing dataset 404. The training dataset 402 may include a first portion of electrical devices, such as P-channel transistors with standard threshold voltages, namely, pch_svt_1 to pch_svt_n. Additionally, the device parameter set for each electrical device pch_svt_1 to pch_svt_n within the training dataset 402 may include a respective measured performance, such as PF1 to PFn, which has already been verified by real pre-layout or post-layout simulation, and used as a label for each device parameter set. Examples of the measured performance for each electrical device within the training dataset 402 may include at least a transconductance gₘ and a saturation current I_{dsat} thereof. Once all electrical devices and their respective device parameter sets with verified performance are input to the machine-learning model ML_m for training, the flow 300 proceeds to operation 306.

At operation 306, a performance of each electrical device within a testing dataset within the device dataset is predicted using the trained machine-learning model. In some embodiments, the testing dataset 404 may constitute a relatively large portion of the device dataset 400 compared to the training dataset 402. For example, millions of electrical devices could be included in the device dataset 400 for the specific technology node, and the number of electrical devices may increase with the improvement of the recipe or process at the specific technology node. Additionally, there may be sub-versions or improved versions of the specific technology node, resulting in an increasing number of electrical devices within the device dataset 400. Accordingly, it may be impractical to verify the performance for each electrical device within the testing dataset 404 using real schematic simulation, pre-layout simulation, or post-layout simulation.

At operation 308, the predicted performance of each electrical device within the testing dataset 404 is verified. In some embodiments, during the testing phase of the machine-learning model ML_m, the performances of a certain number of electrical devices within the testing dataset 404 can be verified through the verification stage. For example, the predicted performance of each electrical device within the certain number of electrical devices can be compared with the real performance thereof, and a performance mismatch score therebetween can be calculated. When the performance mismatch score is less than a predetermined percentage (e.g., 5%), it indicates that the predicted performance of the electrical device generated by the machine-learning model ML_m is trustable. When the performance mismatch score exceeds the predetermined percentage (e.g., 5%), it indicates that the predicted performance of the electrical device generated by the machine-learning model ML_m is not accurate enough. Additionally, the performance mismatch score of each electrical device among the certain number of electrical devices within the testing dataset 404 can be used as feedback information provided to the machine-learning model ML_m. In some embodiments, a back-propagation technique can be incorporated into the machine-learning model ML_m, allowing the machine-learning model ML_m to improve its accuracy for inference using the feedback information.

In some embodiments, the performance mismatch score PMS between the predicted performance and the real performance of a specific electrical device can be expressed using formula (1) as follows.

$$PMS ( \% ) = ( \frac{( g {m}_{real} - g {m}_{pred}}{g {m}_{pred}} ) \times gmWeight + ( \frac{( i {d}_{real} - i {d}_{pred}}{i {d}_{pred}} ) \times idWeight \qquad ( 1 )$$

where gmᵣₑₐₗ and idᵣₑₐₗ denote the transconductance (e.g., in units of μS) and saturation current (e.g., in units of μA) of the real performance, respectively; gm_{pred} and id_{pred} denote the transconductance and saturation current of the predicted performance, respectively; gmWeight and idWeight denote weight factors of the transconductance and saturation current, respectively. In some cases, the weight factors gmWeight and idWeight are equal to 0.5.

At operation 310, it is determined whether all technology nodes are processed. When it is determined that all technology nodes are processed, the flow 300 ends. When it is determined that not all technology nodes are processed, operation 312 is performed to select a next technology node. In other words, the loop from operations 302 to 312 can be performed repeatedly until the machine-learning models ML1 to ML_N for all technology nodes (e.g., node 1 to node N) are processed.

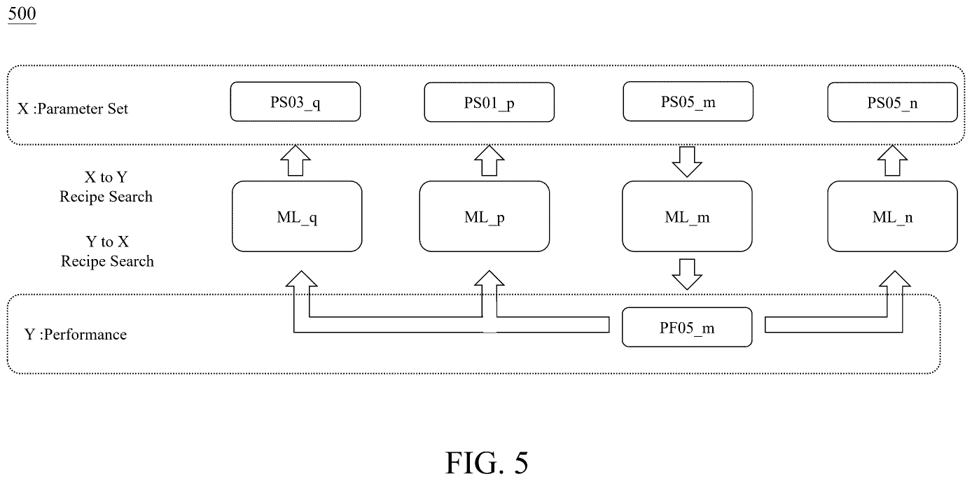

FIG. 5 is a diagram illustrating mutual recipe search for a specific electrical device between different technology nodes in accordance with some embodiments of the present disclosure.

For purposes of description, technology node m is a source node, while technology nodes n, p, and q are target nodes, where m, n, p, and q are different positive integers between 1 and N. For brevity, the relationships between the numbers m, n, p, and q are expressed as q>p>m>n, indicating that technology node n has the smallest gate width, while technology node q has the largest gate width. Additionally, transistor devices utilizing technology node q may be planar FETs, transistor devices utilizing technology nodes p and m may be finFETs with different gate widths, and transistor devices utilizing technology node n may be nanosheet FETs.

In some embodiments, PS05_m refers to the device parameter set for the fifth indexed electrical device utilizing technology node m, while PF05_m denotes the predicted performance for the fifth indexed electrical device generated by the machine-learning model ML_m for technology node m. For example, the device parameter set PS05_m is input into the machine-learning model ML_m to generate a predicted performance PF05_m (e.g., X to Y recipe search). It should be noted that the machine-learning models ML_q, ML_p, and ML_n may possess a backward inference function. Accordingly, the predicted performance PF05_m generated by the machine-learning model ML_m can be input into the machine-learning models ML_q, ML_p, and ML_n for backward inference (e.g., Y to X recipe search), enabling the machine-learning models ML_q, ML_p, and ML_n to generate respective device parameter sets PS03_q, PS01_p, and PS05_n, which exhibit similar performance to PF05_m for technology nodes q, p, and n, respectively. Therefore, the flow shown in FIG. 5 is capable of performing mutual recipe search to obtain electrical devices with similar performance even if different technology nodes or transistor structures are used.

FIG. 6 is a diagram illustrating the flow for selecting the most suitable electrical device from a plurality of technology nodes in accordance with some embodiments of the present disclosure.

In some embodiments, the machine-learning model 1045 may be a full-technology-node machine-learning model which is a collection of a plurality of machine-learning models ML1 to ML_N for different technology nodes. When a device parameter set of a specific electrical device is input into the machine-learning model 1045, it indicates that the device parameter set is input into individual machine-learning models ML1 to ML_N included in the machine-learning model 1045.

In some embodiments, the device parameter set 600 of a first electrical device may include the technology node being used (e.g., N3), first goal (e.g., minimum noise), the number of fins (e.g., nfin=2), and the channel length (e.g., length=3 nm) thereof. For brevity, a 3 nm technology node (e.g., N3) is utilized by the first electrical device. Additionally, the full-node machine-learning model 1045 allows the input device parameter set to include one or more goals, which may help to determine the most suitable electrical device from a plurality of candidate electrical devices generated by the machine-learning models ML_1 to ML_N. For simplicity, the device parameter set 600 includes a first goal of minimum noise, indicating that, in addition to similar performance of the transconductance and saturation current, the selected electrical device should have the minimum noise among the candidate electrical devices utilizing different technology nodes.

Specifically, when the device parameter set 600 is input into the machine-learning model 1045, the machine-learning model ML_m corresponding to the technology node included in the device parameter set 600 generates a predicted performance based on the device parameter set 600. Subsequently, the predicted performance of the first electrical device is input into the machine-learning models other than the machine-learning model ML_m within the machine-learning model 1045, each performing backward inference based on the predicted performance of the specific electrical device utilizing the technology node m to generate one or more candidate electrical device parameter sets with performance similar to the predicted performance. Accordingly, the machine-learning model 1045 (e.g., processor 102) can select the most suitable electrical device from the candidate electrical device parameter sets generated by different machine-learning models based on the first goal included in the device parameter set 600, where the device parameter set 602 selected from a plurality of candidate electrical device parameter sets corresponds to the most suitable electrical device with the minimum noise, and it includes a 6 nm technology node (e.g., Node=N6), a number of fins (nfin=2), and a channel length (e.g., length=8 nm).

In some embodiments, the device parameter set 610 of a second electrical device may include the technology node being used (e.g., Node=N3), first goal (e.g., highest speed or operating frequency), number of fins (e.g., nfin=2), and channel length (e.g., length=3 nm) thereof. When the device parameter set 610 is input into the full-technology-node machine-learning model 1045, a similar procedure is performed as with the device parameter set 600. Accordingly, the machine-learning model 1045 (e.g., processor 102) can select the most suitable electrical device from the candidate electrical device parameter sets generated by different machine-learning models based on the first goal included in the device parameter set 610. The device parameter set 612, selected from a plurality of candidate electrical device parameter sets, corresponds to the most suitable electrical device with the highest speed and includes a 2 nm technology node (e.g., Node=N2), a channel width (width=32 nm), and a channel length (e.g., length=3 nm). Accordingly, the full-technology-node machine-learning model 1045 can generate the most suitable electrical device that utilizes a technology node other than the one included in the input device parameter set, has similar performance to the source electrical device associated with the input device parameter set, and satisfies one or more goals within the input device parameter set.

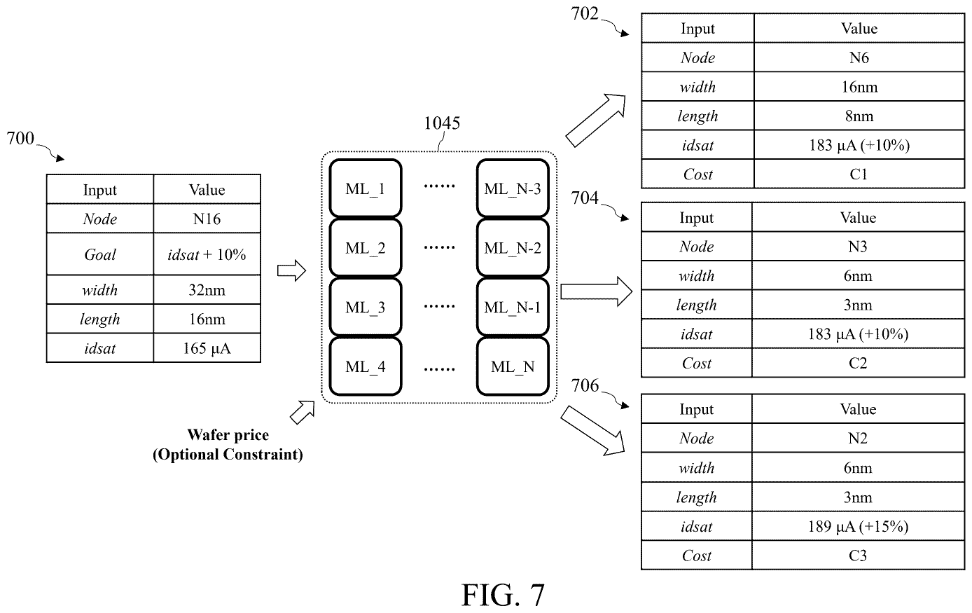

FIG. 7 is a diagram illustrating the flow for selecting the most suitable electrical device from a plurality of technology nodes using an input device parameter set and an additional constraint in accordance with some embodiments of the present disclosure.

In some embodiments, the device parameter set 700 of a specific electrical device may include the technology node being used (e.g., 16 nm technology node N16), first goal (e.g., idsat+10%), the channel width (e.g., width=32 nm), the channel length (e.g., length=16 nm), and the saturation current (e.g., idsat=165 μA) thereof. It should be noted that the device parameter set 700 includes more parameters than device parameter sets 600 or 602 shown in FIG. 6. In some embodiments, the saturation current idsat (e.g., 165 μA) may be a reference numeral value to the goal (e.g., idsat+10%) included in the device parameter set 700, indicating that the candidate electrical devices generated by the machine-learning model 1045 should satisfy the goal. Additionally, an additional constraint, such a wafer price (e.g., in US dollars per unit area), is applied to the machine-learning model 1045, such that the costs for the candidate electrical devices are included in their respective device parameter sets 702, 704, and 706, such as C1, C2, and C3. When the cost C2 is lower than costs C1 and C3, the candidate electrical device associated with the device parameter set 704 is determined as the most suitable electrical device for schematic migration from the source electrical device using a first technology node (e.g., N16) to the target electrical device using a second technology node (e.g., N3).

It should be noted that there may be more than one candidate electrical devices generated by each machine-learning model ML1 to ML_N. The candidate electrical devices utilizing the same technology node with saturation currents significantly higher than the goal (e.g., idsat+10%), which may have potential high prices due to their high driving capability, can be filtered out. The candidate electrical device with the saturation current barely satisfying the goal can be used. This indicates that the candidate electrical device with the least saturation current satisfying the goal is selected for one of the technology nodes. Accordingly, the candidate electrical devices associated the device parameter sets 702, 704, and 706 utilizing the 6 nm, 3 nm, and 2 nm technology nodes are selected from the candidate electrical devices associated respective technology nodes. Furthermore, the candidate electrical device associated the device parameter set 704 is determined as the most suitable electrical device complying with both the goal included in the input device parameter set 700 and the additional constraint of the wafer price. It should be noted that the numerical values described in the embodiments of FIGS. 4 to 7 are for illustrative purposes, and the present disclosure is not limited thereto.

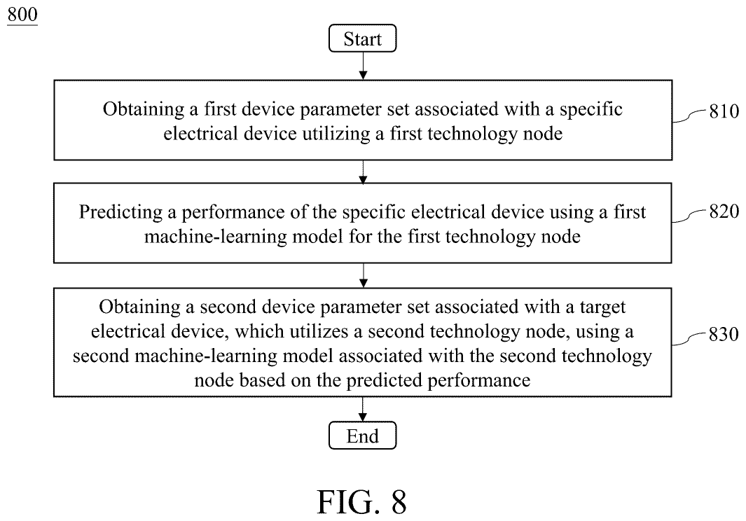

FIG. 8 is a flowchart of a method for schematic migration of an electrical component between different technology nodes in accordance with some embodiments of the present disclosure. Please refer to both FIG. 1 and FIG. 8 simultaneously.

At operation 810, a first device parameter set associated with a specific electrical device utilizing a first technology node is obtained. In some embodiments, the specific electrical device may be a transistor device of different types utilizing the first technology node. From the perspective of types, the specific electrical device may be a P-type or N-type, standard threshold voltage (SVT) device, a low threshold voltage (LVT) device, an ultra-low threshold voltage (uLVT) device, a high threshold voltage (HVT) device, an ultra-high threshold voltage (uHVT) device, and the like. From the perspective of structure, the specific electrical device may be a planar FET, a finFET, or a nanosheet FET, depending on the first technology node. In some embodiments, the specific electrical device may be CMOS (complementary metal oxide semiconductor) logic gates utilizing the first technology node.

In some embodiments, the device parameter set may include one or more parameters associated with the specific electrical device, depending on the type and structure thereof. For example, the one or more parameters may be size information (e.g., transistor size) about the specific electrical device. For example, the transistor size may refer to a channel width (W) and channel length (L) for a planar FET, a number of fins (nfin) and channel length (L) for a finFET, or a number of channels or nanosheets (n_ns) and channel length (L) for a nanosheet FET. It should be noted that the device parameter set (e.g., recorded in a CDF file) for each instance or electrical device is not limited to the technology node and transistor size thereof, and it may include more information.

At operation 820, a performance of the specific electrical device is predicted using a first machine-learning model for the first technology node. In some embodiments, the performance of the specific electrical device may include, but is not limited to, information about transistor size, depending on the first technology node. For example, the transistor size may refer to a channel width (W) and channel length (L) for a planar FET, a number of fins (nfin) and channel length (L) for a finFET, or a number of channels or nanosheets (n_ns) and channel length (L) for a nanosheet FET. It should be noted that the device parameter set (e.g., recorded in a CDF file) for each instance or electrical device is not limited to the technology node and transistor size thereof, and it may include more information.

At operation 830, a second device parameter set associated with a target electrical device, which utilizes a second technology node, is obtained using a second machine-learning model associated with the second technology node based on the predicted performance. In some embodiments, the second technology node may be smaller than the first technology node, indicating that it corresponds to a smaller feature size, such as minimum gate width, compared to the first technology node. In some embodiments, the second machine-learning model performs backward inference based on the predicted performance of the specific electrical device utilizing the first technology node to obtain the target electrical device utilizing the second technology node, which has similar performance to the predicted performance of the specific electrical device.

Accordingly, the method 800 shown in FIG. 8 can be performed to find similar electrical components in different technology nodes more efficiently, thereby quickly reproducing the performance of the original IC design in a smaller technology node which possibly employs a different structure of electrical devices.

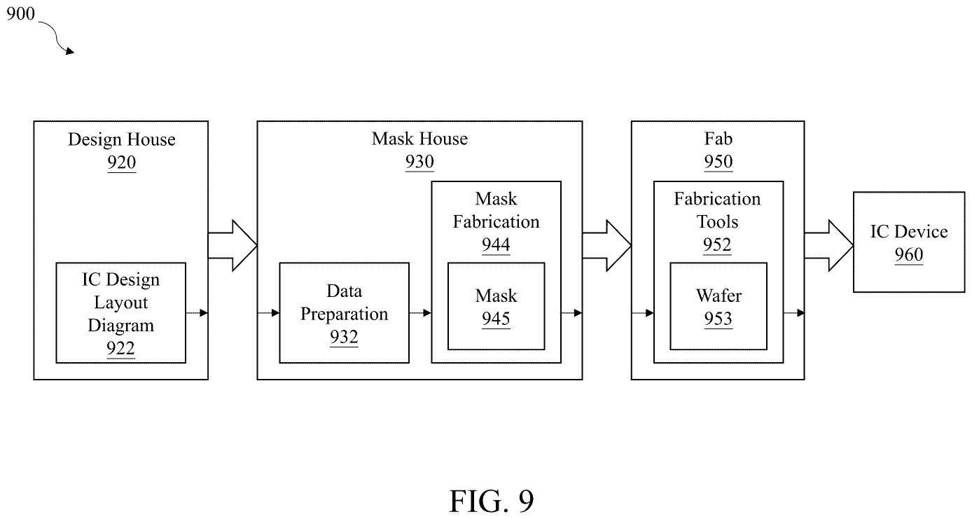

FIG. 9 is a block diagram of an IC manufacturing system 900, and an IC manufacturing flow associated therewith, in accordance with some embodiments. In some embodiments, based on an IC layout diagram, at least one of (A) one or more semiconductor masks or (B) at least one component in a layer of a semiconductor integrated circuit is fabricated using manufacturing system 900.

In FIG. 9, IC manufacturing system 900 includes entities, such as a design house 920, a mask house 930, and an IC manufacturer/fabricator (“fab”) 950, that interact with one another in the design, development, and manufacturing cycles and/or services related to manufacturing an IC device 960. The entities in system 900 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 920, mask house 930, and IC fab 950 is owned by a single larger company. In some embodiments, two or more of design house 920, mask house 930, and IC fab 950 coexist in a common facility and use common resources.

The design house (or design team) 920 generates an IC design layout diagram 922, which is obtained using schematics of electrical devices that utilize a smaller technology node migrated from a larger technology node, employing the methods described in the embodiments of FIGS. 1 to 8. IC design layout diagram 922 includes various geometrical patterns, such as the IC layout diagram discussed above. These geometrical patterns correspond to patterns of metal, oxide, or semiconductor layers that constitute the various components of IC device 960 to be fabricated. The various layers combine to form different IC features. For example, a portion of IC design layout diagram 922 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. Design house 920 implements an appropriate design procedure to form IC design layout diagram 922. The design procedure includes one or more of logic design, physical design, or place and route. IC design layout diagram 922 is presented in one or more data files containing information about the geometrical patterns. For example, IC design layout diagram 922 can be expressed in a GDSII file format or DFII file format.

Mask house 930 includes data preparation 932 and mask fabrication 944. Mask house 930 uses IC design layout diagram 922 to manufacture one or more masks 945 to be used for fabricating the various layers of IC device 960 according to IC design layout diagram 922. Mask house 930 performs mask data preparation 932, where IC design layout diagram 922 is translated into a representative data file (RDF). Mask data preparation 932 provides the RDF to mask fabrication 944. Mask fabrication 944 includes a mask writer. A mask writer converts the RDF to an image on a substrate, such as mask (reticle) 945 or a semiconductor wafer 953. The design layout diagram 922 is manipulated by mask data preparation 932 to comply with particular characteristics of the mask writer and/or requirements of IC fab 950. In FIG. 9, mask data preparation 932 and mask fabrication 944 are illustrated as separate elements. In some embodiments, mask data preparation 932 and mask fabrication 944 can be collectively referred to as mask data preparation.

In some embodiments, mask data preparation 932 includes optical proximity correction (OPC) which uses lithography enhancement techniques to compensate for image errors, such as those that can arise from diffraction, interference, other process effects and the like. OPC adjusts IC design layout diagram 922. In some embodiments, mask data preparation 932 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, mask data preparation 932 includes a mask rule checker (MRC) that checks the IC design layout diagram 922 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout diagram 922 to compensate for limitations during mask fabrication 944, which may undo part of the modifications performed by OPC in order to meet mask creation rules.

In some embodiments, mask data preparation 932 includes lithography process checking (LPC) that simulates processing that will be implemented by IC fab 950 to fabricate IC device 960. LPC simulates this processing based on IC design layout diagram 922 to create a simulated manufactured device, such as IC device 960. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been created by LPC, if the simulated device is not close enough in shape to satisfy design rules, OPC and/or MRC are be repeated to further refine IC design layout diagram 922.

It should be understood that the above description of mask data preparation 932 has been simplified for the purposes of clarity. In some embodiments, data preparation 932 includes additional features such as a logic operation (LOP) to modify the IC design layout diagram 922 according to manufacturing rules. Additionally, the processes applied to IC design layout diagram 922 during data preparation 932 may be executed in a variety of different orders.

After mask data preparation 932 and during mask fabrication 944, a mask 945 or a group of masks 945 are fabricated based on the modified IC design layout diagram 922. In some embodiments, mask fabrication 944 includes performing one or more lithographic exposures based on IC design layout diagram 922. In some embodiments, an electron-beam (e-beam) or a mechanism of multiple e-beams is used to form a pattern on a mask (photomask or reticle) 945 based on the modified IC design layout diagram 922. Mask 945 can be formed in various technologies. In some embodiments, mask 945 is formed using binary technology. In some embodiments, a mask pattern includes opaque regions and transparent regions. A radiation beam, such as an ultraviolet (UV) or EUV beam, used to expose the image sensitive material layer (e.g., photoresist) which has been coated on a wafer, is blocked by the opaque region and transmits through the transparent regions. In one example, a binary mask version of mask 945 includes a transparent substrate (e.g., fused quartz) and an opaque material (e.g., chromium) coated in the opaque regions of the binary mask. In another example, mask 945 is formed using a phase shift technology. In a phase shift mask (PSM) version of mask 945, various features in the pattern formed on the phase shift mask are configured to have proper phase difference to enhance the resolution and imaging quality. In various examples, the phase shift mask can be attenuated PSM or alternating PSM. The mask(s) generated by mask fabrication 944 is used in a variety of processes. For example, such a mask(s) is used in an ion implantation process to form various doped regions in semiconductor wafer 953, in an etching process to form various etching regions in semiconductor wafer 953, and/or in other suitable processes.

IC fab 950 is an IC fabrication business that includes one or more manufacturing facilities for the fabrication of a variety of different IC products. In some embodiments, IC Fab 950 is a semiconductor foundry. For example, there may be a manufacturing facility for the front end fabrication of a plurality of IC products (front-end-of-line (FEOL) fabrication), while a second manufacturing facility may provide the back end fabrication for the interconnection and packaging of the IC products (back-end-of-line (BEOL) fabrication), and a third manufacturing facility may provide other services for the foundry business.

IC fab 950 includes wafer fabrication tools 952 configured to execute various manufacturing operations on semiconductor wafer 953 such that IC device 960 is fabricated in accordance with the mask(s), e.g., mask 945. In various embodiments, fabrication tools 952 include one or more of a wafer stepper, an ion implanter, a photoresist coater, a process chamber, e.g., a CVD chamber or LPCVD furnace, a CMP system, a plasma etch system, a wafer cleaning system, or other manufacturing equipment capable of performing one or more suitable manufacturing processes as discussed herein.

IC fab 950 uses mask(s) 945 fabricated by mask house 930 to fabricate IC device 960. Thus, IC fab 950 at least indirectly uses IC design layout diagram 922 to fabricate IC device 960. In some embodiments, semiconductor wafer 953 is fabricated by IC fab 950 using mask(s) 945 to form IC device 960. In some embodiments, the IC fabrication includes performing one or more lithographic exposures based at least indirectly on IC design layout diagram 922. Semiconductor wafer 953 includes a silicon substrate or other proper substrate having material layers formed thereon. Semiconductor wafer 953 further includes one or more of various doped regions, dielectric features, multilevel interconnects, and the like (formed at subsequent manufacturing steps).

An aspect of the present disclosure provides a method, which includes the following steps: obtaining, by a processor, a first device parameter set associated with a specific electrical device utilizing a first technology node; predicting, by the processor, a performance of the specific electrical device using a first machine-learning model for the first technology node; and obtaining, by the processor, a second device parameter set associated with a target electrical device, which utilizes a second technology node, using a second machine-learning model associated with the second technology node based on the predicted performance.

Another aspect of the present disclosure provides a system which includes a non-transitory computer-readable medium storing program instructions and a processor. The non-transitory computer-readable medium includes program instructions. The processor is operatively coupled to the non-transitory computer-readable medium. The program instructions, when executed by the processor, cause the processor to perform specific functions. The method includes the following steps: obtaining a first device parameter set associated with a specific electrical device utilizing a first technology node; inputting the first device parameter to a full-node machine-learning model, which includes a plurality of machine-learning models for a plurality of technology nodes, to obtain one or more candidate device parameter sets associated with the technology nodes other than the first technology node; and determining a target electrical device associated with a target device parameter set selected from the one or more candidate device parameter sets.

Yet another aspect of the present disclosure provides a system which includes a non-transitory computer-readable medium storing program instructions and a processor operatively coupled to the non-transitory computer-readable medium. The program instructions, when executed by the processor, cause the processor to perform specific tasks. The method includes the following steps: obtaining a device dataset which includes a plurality of device parameter sets associated with a plurality of electrical devices utilizing a first technology node; dividing the device dataset into a training dataset and a testing dataset, where the training dataset includes a first portion of the plurality of device parameter sets and respective performances; training a first machine-learning model for the first technology node using the training dataset during a training phase of the first machine-learning model; and verifying the first machine-learning model using the testing dataset during a testing phase of the first machine-learning model.

The methods and features of the present disclosure have been sufficiently described in the provided examples and descriptions. It should be understood that any modifications or changes without departing from the spirit of the present disclosure are intended to be covered in the protection scope of the present disclosure.

Moreover, the scope of the present application is not intended to be limited to the particular embodiments of the process, machine, manufacture, and composition of matter, means, methods and steps described in the specification. As those skilled in the art will readily appreciate from the present disclosure, processes, machines, manufacture, composition of matter, means, methods or steps presently existing or later to be developed, that perform substantially the same function or achieve substantially the same result as the corresponding embodiments described herein, can be utilized according to the present disclosure.

Accordingly, the appended claims are intended to include within their scope processes, machines, manufacture, compositions of matter, means, methods or steps. In addition, each claim constitutes a separate embodiment, and the combination of various claims and embodiments are within the scope of the present disclosure.

What is claimed is:

1. A method, comprising:
obtaining, by a processor, a first device parameter set associated with a specific electrical device utilizing a first technology node;
predicting, by the processor, a performance of the specific electrical device using a first machine-learning model for the first technology node; and
obtaining, by the processor, a second device parameter set associated with a target electrical device, which utilizes a second technology node, using a second machine-learning model associated with the second technology node based on the predicted performance.

2. The method of claim 1, wherein the first device parameter set comprises first size information about the specific electrical device.

3. The method of claim 2, wherein the first size information comprises a channel width and a channel length when the specific electrical device is a planar field-effect transistor device.

4. The method of claim 2, wherein the first size information comprises a number of fins and a channel length when the specific electrical device is a fin field-effect transistor device.

5. The method of claim 2, wherein the first size information comprises a number of channels and a channel length when the specific electrical device is a nanosheet field-effect transistor device.

6. The method of claim 1, wherein the performance of the specific electrical device comprises a transconductance and a saturation current of the specific electrical device.

7. The method of claim 6, wherein the performance of the specific electrical device further comprises a noise suppression capability.

8. The method of claim 1, wherein the second technology node is smaller than the first technology node.

9. The method of claim 8, wherein the first technology node and the second technology node employ different structures for the specific electrical device and the target electrical device, respectively.

10. The method of claim 1, wherein the first machine-learning model and the second machine-learning model comprise invertible neural networks or autoencoders with a backward inference function.

11. The method of claim 1, wherein:
a training procedure of the first machine-learning model comprises a training phase and a testing phase; and
during the training phase, the first machine-learning model is trained using a first device dataset comprising a plurality of device parameter sets associated with a plurality of electrical devices utilizing the first technology node.

12. The method of claim 11, wherein:
the first device dataset is divided into a training dataset and a testing dataset;
the training dataset comprises a first portion of the plurality of device parameter sets and respective performances;
the testing dataset comprises a remaining portion of the plurality of device parameter sets; and
during the testing phase, the testing dataset is used to verify the first machine-learning model during the testing phase.

13. The method of claim 12, wherein predicted performances generated from the testing dataset is sent to a verification stage to generate feedback information fed back to the first machine-learning model during the testing phase.

14. A system comprising a non-transitory computer-readable medium storing program instructions; and a processor operatively coupled to the non-transitory computer-readable medium, wherein the program instructions, when executed by the processor, cause the processor to perform:
obtaining a first device parameter set associated with a specific electrical device utilizing a first technology node;
inputting the first device parameter to a full-node machine-learning model, which comprises a plurality of machine-learning models for a plurality of technology nodes, to obtain one or more candidate device parameter sets associated with the technology nodes other than the first technology node; and
determining a target electrical device associated with a target device parameter set selected from the one or more candidate device parameter sets.

15. The system of claim 14, wherein the first device parameter set comprises size information of the specific electrical device and a goal.

16. The system of claim 15, wherein the processor selects the target device parameter set from the one or more candidate device parameter sets based on the goal in the first device parameter set.

17. The system of claim 15, wherein an additional constraint is applied to the full-node machine-learning model, and the processor selects the target device parameter set from the one or more candidate device parameter sets based on the additional constraint and the goal in the first device parameter set.

18. The system of claim 17, wherein the additional constraint comprises a wafer price per unit area.

19. A system comprising a non-transitory computer-readable medium storing program instructions; and a processor operatively coupled to the non-transitory computer-readable medium, wherein the program instructions, when executed by the processor, cause the processor to perform:
obtaining a device dataset comprising a plurality of device parameter sets associated with a plurality of electrical devices utilizing a first technology node;
dividing the device dataset into a training dataset and a testing dataset, wherein the training dataset comprises a first portion of the plurality of device parameter sets and respective performances;
training a first machine-learning model for the first technology node using the training dataset during a training phase of the first machine-learning model; and
verifying the first machine-learning model using the testing dataset during a testing phase of the first machine-learning model.

20. The system of claim 19, wherein the processor further performs:
sending, during the testing, performance results generated by the first machine-learning model phase to a verification stage to generate feedback information; and
sending the feedback information to the first machine-learning model during the testing phase,
wherein the feedback information comprises a performance mismatch score for each device parameter set within the testing dataset.
